(19) United States
(12) Patent Application Publication
(10) Pub. No.: US 2024/0190363 A1
(43) Pub. Date: Jun. 13, 2024

(54) MOTOR VEHICLE BODY PANEL

(71) Applicant: COMPAGNIE PLASTIC OMNIUM SE, LYON (FR)

(72) Inventor: Olivier CORNET, Sainte-Julie (FR)

(73) Assignee: COMPAGNIE PLASTIC OMNIUM SE, LYON (FR)

(21) Appl. No.: 18/535,449

(22) Filed: Dec. 11, 2023

(30) Foreign Application Priority Data
Dec. 12, 2022 (FR) 2213186

(51) Int. Cl. B60R 13/04; B62D 25/02; B62D 29/04

(52) U.S. Cl. CPC B60R 13/04; B62D 25/02; B62D 29/043

(57) ABSTRACT

The present disclosure relates to a motor vehicle body panel, including at least one covering with a thickness of between 0.1 and 1.5 millimeter, preferably between 0.3 and 0.7 millimeters, forming a main body of the body panel, the covering being attached to at least one plastic support forming at least part of a frame of the body panel.

The present disclosure relates to motor vehicle body panels made of plastic material.

The plastic body panels, for example a bumper skin or an exterior tailgate panel, are commonly made by injection molding, for example using polypropylene or polycarbonate (other plastic materials can be used for this molding).

Saving weight has become a central issue for present and future developments in automotive equipment, and body panels are included in this issue. For example, it is known to mold body panels by decreasing the plastic material thickness locally at the body panel or over the entirety of the latter or by reducing the density of the plastic material used. For example, for a bumper skin, it is possible to reduce the thickness of the panel up to 2.7 millimeters or even to 2.5 millimeters (it is also possible to lower the thickness locally to 1.9 millimeters, or even to 1.6 millimeters). In the same way, it is possible to reduce the density of the plastic material used, for example between 0.9 and 1.20 for polypropylene (in particular as a function of the filler content, typically talc).

However, excessive reduction in the thickness of the body panels as well as the density of the plastic material used may lead to appearance defects, degraded mechanical performance of the body panel, or industrial production difficulties in injection molding. These consequences are not acceptable for their use on exterior body panels visible on a motor vehicle. Therefore, the reductions in the thickness or density of a body panel are thus limited to these aspect, resistance and production constraints. Thus, depending on the choices made in thickness, in material density, and on redesigns made necessary by these changes while remaining at equivalent performance, it is possible to obtain weight savings limited to about 5% to 15% only.

Another embodiment consists in making recesses by molding. Indeed, in injection it is possible to reduce the mass of a panel by producing weight reducing recesses during molding, but this creates appearance defects (in particular weld lines), which are not acceptable in terms of quality if the part is visible from the outside, or to hide it behind another solid part.

The object of the present disclosure is to provide an exterior body panel formed by elements making it possible to reduce the weight thereof relative to the body panels of the prior art while avoiding the disadvantages mentioned above and known from the prior art.

To this end, the present disclosure relates to a motor vehicle body panel, including at least one covering with a thickness of between 0.1 and 1.5 millimeter, preferably between 0.3 and 0.7 millimeters, forming a main body of the body panel, the covering being attached to at least one support made of plastic material forming at least part of a frame of the body panel.

The term “covering” refers to a part attached to a frame and forming the main body of the body panel, without covering the surface of another element of the body panel.

Thus, and in replacement for an injected body panel made of plastic material, a covering of much lesser thickness is produced. It is not necessary to reduce the density of the plastic material used. The weight saving is achieved by virtue of a much greater reduction in thickness due to manufacturing of the covering. In addition, the support is itself made of plastic material, which also makes it possible to contribute to weight reduction of the body panel. Therefore, the panel obtained may have a weight that is a half of that of a body panel obtained by injection molding and for an identical covered surface. It is possible to obtain a panel whose main body is light and thin, while at the same time achieving sufficient mechanical strength to form a motor vehicle body panel, thus obtaining a body panel that is satisfactory in terms of strength compared with a conventional panel, for example made of injected plastic, while at the same time making said body panel lighter.

According to additional features of the body panel taken alone or in combination:
the covering is chosen from a plastic film, a perforated plastic material covering, preferably a woven plastic covering, or a natural fiber woven or knitted covering;
the covering is configured so as to allow elastic deformation in tension in an extension plane of the covering of between 1% and 50%, preferably between 3% and 10%;
at least part of the covering includes openings whose size is between 1 millimeter and 50 millimeters, preferably between 10 millimeters and 40 millimeters;
at least a part of the covering includes at least one decorative design;
the decorative design is formed by a material forming the covering when the covering is made of woven or knitted plastic or woven natural fiber;
the covering is made based on at least one plastic material chosen from polypropylene, polyamide, polyurethane, polyvinyl chloride, polyester or elastane;
the covering is rigidly attached to the support, for example by welding, by adhesive bonding, by riveting or by overmolding the covering on the support;
the covering is removably attached to the support, for example by clamping of the covering by the support;
the support includes means for fastening the body panel to a structure of a motor vehicle;
the body panel includes multiple supports on which at least one covering is mounted;
the support is made based on at least one plastic material selected from polypropylene, polyamide, polyvinyl chloride, polyester, polybutylene terephthalate, or with a composite material base;
the covering is stretched over the support;
the support includes at least one support bar for the covering;
at least one support bar extends over an external face of the covering; and
at least one support bar locally deforms the covering.

The present disclosure also relates to a motor vehicle including at least one body panel according to the disclosed embodiments.

The present disclosure also relates to a method for manufacturing a motor vehicle body panel according to the present disclosure, wherein:
at least one support made of plastic material is made,
at least one covering is made, and
the covering is fixed to the support.

Preferably, multiple plastic supports are made, at least one covering is fixed on the supports, and the body panel is folded on itself.

### BRIEF DESCRIPTION OF THE FIGURES

The present disclosure will be better understood upon reading the following description, which is provided merely as example and with reference to the appended drawings, wherein:

FIG. 1 is a perspective view of part of a body panel according to an embodiment.

FIG. 2 is a perspective view of part of a body panel according to an embodiment, including a decorative design.

FIG. 3 is a perspective view of part of a body panel according to one embodiment.

FIG. 4 is a perspective view of part of a body panel according to another embodiment.

FIG. 5 is a perspective view of part of a body panel according to yet another embodiment.

### DETAILED DESCRIPTION

The following terms are used in the following text:
“opening”: any through opening provided in the covering, making it possible to obtain an openwork covering (that is, which includes openings),
“mesh”: regular or non-regular material loops, the interweaving of which forms a woven or knitted covering, and
“perforation”: hole made mechanically in the initially solid covering.

Reference is now made to [FIG. 1] showing a part of a body panel 2. This body panel 2 may be a front, rear bumper, an exterior panel of a tailgate, a door panel, etc.

This is a panel visible from the outside of the motor vehicle when it is mounted on said motor vehicle. This body panel is fixed and not deployable. This means that it does not includes any part movable relative to the rest of the body panel 2, and that it does not undergo deformation during normal deployment in order to drive.

The body panel 2 includes at least one covering 4 with a thickness of between 0.1 and 1.5 millimeter, preferably between 0.3 and 0.7 millimeters, forming a main body of the body panel 2. Therefore, and as explained above, it is a much thinner covering than those of the body panels according to the prior art.

Advantageously, the covering 4 is chosen from a solid film made of plastic material (one or more plastics), a perforated covering made of plastic material, preferably a woven covering made of plastic material, or a woven or knitted covering based on natural fibers.

As regards the possibility of producing a solid film made of plastic material, it may for example be a film obtained by extrusion. This film could for example be cut subsequently to the dimensions of the body panel.

As regards the possibility of producing a perforated covering made of plastic material, it may be a plastic film wherein perforations are made after manufacturing the film on at least part of the film. Alternatively, it may be a fabric made by weaving fibers made of plastic or natural material, potentially coated with another material.

An example of a plastic film including plastic fibers is a film including molecularly oriented thermoplastic fibers, e.g. of polypropylene, which are woven and bonded to a matrix made of the same plastic, e.g. of polypropylene. Such a material used as the main body of a body panel makes it possible, as explained above, to achieve a significant weight saving compared to a conventional panel while guaranteeing satisfactory strength and rigidity, particularly in terms of impact resistance. Used in the form of die-cut or pressure-formed sheets, such a material has optimum behavior in the event of a collision, thanks to optimal energy absorption, and good wear resistance.

As regards a woven or knitted covering made of natural fibers, mention may be made, for example, of a covering made of cotton fibers or of flax fibers. Here again, it would be possible to coat this plastic material fabric.

In the case wherein the covering 4 is at least partially perforated (by making perforations or by the presence of open meshes), it may include openings 6 (shown in the figures for illustrative purposes without observing real dimensions) whose size can be between 1 millimeter and 50 millimeters, preferably between 10 millimeters and 40 millimeters. The presence of openings 6 in particular makes it possible to allow air to pass in the case where the body panel 2 is an element opposing an air flow, in particular when the vehicle is in motion, which makes it possible to reduce the aerodynamic pressure experienced during the driving of the motor vehicle (in fact, and in the case of a front bumper, the maximum pressure that can be exerted can reach 250 N/m² at 70 km/h, 550 N/m² to 110 km/h, and 1200 N/m² at 160 km/h), or to allow minimum ventilation of the parts of the motor vehicle placed behind the body panel 2.

Advantageously, the covering 4 is configured so as to allow an elastic deformation of between 1% and 50%, preferably between 3% and 10%. This deformation is measured in tension, on the complete covering 4 and extending in a single plane. Thus, the body panel 2 can deform in the event of pressure exerted thereon. This is to avoid deterioration of the body panel 2, either by irreversible deformation, or by breaking the covering 4. This possibility of elastic deformation can be achieved thanks to:
the intrinsic elasticity of the material forming the fibers of the covering 4, for example elastane,
the relative density of the fibers and/or of the meshes forming the covering 4, and/or
the weaving technique. This means the possibility given to the fibers and/or the meshes to move within the covering 4.

The covering 4 may for example include at least one plastic material chosen from polypropylene, polyamide, polyurethane, polyvinyl chloride, polyester or elastane. The choice of the material may, inter alia, be carried out by taking into account the deformation permitted by the material forming the covering 4. This choice may also depend on the design technique of the covering 4, the robustness of the material, its aesthetic appearance, etc.

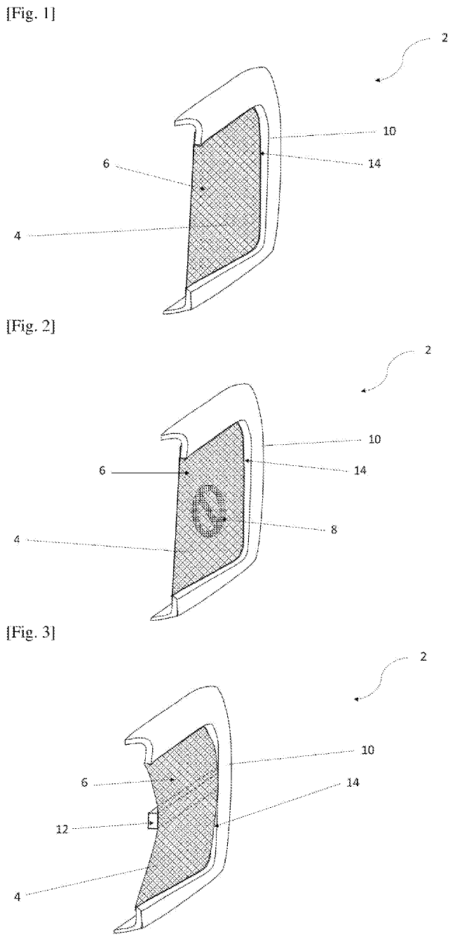

Advantageously, and as shown in [FIG. 2], at least part of the covering 4 may includes at least one decorative design 8. It may therefore be a single decorative design 8 or multiple decorative designs 8, located at an area of the covering 4 or present on the entire covering 4.

Advantageously, and when the covering 4 is made by weaving (synthetic or natural fibers), the decorative design is formed by the material forming the covering 4. It is possible, for example, to modify the weaving at the decorative design(s) 8 or the presence of colored fibers and/or different appearance at the decorative design(s) 8. Alternatively, the decorative design 8 can be attached to the covering 4, for example by printing, paint, etc.

The covering 4 is attached to at least one support 10 made of plastic material forming all or part of a frame of the body panel 2. In other words, the body panel 2 is therefore formed by at least one covering 4 attached to at least one support 10.

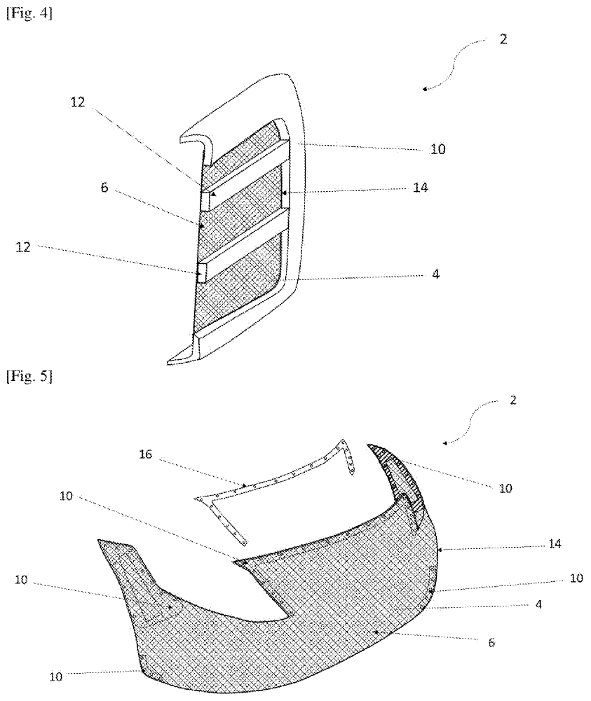

The covering 4 can advantageously be stretched on the support 10. This makes it possible inter alia to obtain an optimal aesthetic result. The support may for example includes one or more support bars 12 (see FIGS. 3 and 4) that can participate in tensioning the covering 4, as can be seen in [FIG. 3] showing a first variant of the body panel 2 according to the various disclosed embodiments.

These support bars can cover an external face 14 of the covering 4 (that is, a face visible from the outside of the vehicle on which the body panel 2 is mounted), for aesthetic purposes and/or for protecting the covering 4. This is visible in [FIG. 4] showing a second variant of the body panel 2 according to an embodiment.

Advantageously, the covering 4 is rigidly attached to the support 10, for example by welding, by adhesive bonding, by riveting or by overmolding the covering 4 on the support 10. This makes it possible to ensure robust anchoring of the covering 4 on the support 10.

Alternatively, the covering 4 can be fixed in different ways to the support 10, for example by clamping of the covering 4 by the support 10. Such a removable fastening makes it possible to consider a simplified replacement of the covering 4 in the event of the latter being damaged during the life of the motor vehicle, or a simplified separation of the covering 4 and of the support 10 during the reprocessing of the body panel 2 for recycling.

Advantageously, the support 10 includes means for fastening the body panel 2 to a structure of a motor vehicle 16. This is visible in [FIG. 5]. Therefore a compact solution for connecting the body panel 2 to the structure of the motor vehicle is obtained, for example by clipping.

It is possible to provide multiple supports 10 on which the covering 4 is attached or multiple coverings 4 are added, as can be seen in [FIG. 5]. It is for example possible to consider multiple supports 10 with edges between them, contiguous or not, with different colors and/or appearance, made from different materials, for example between two adjacent supports 10.

It is possible, for example, to envisage producing a body panel 2 including multiple supports 10, a covering 4 being attached to each support 10, all of the supports 10 being contiguous so as to form the frame of the body panel 2.

The support 10 can be made based on at least one plastic material chosen from polypropylene, polyamide, polyvinyl chloride, polyester, polybutylene terephthalate, or based on a composite material.

The use of multiple supports 10 on which one or more coverings 4 are attached makes it possible to consider a delivery of a body panel 2 assembled in a folded manner.

As regards the method for manufacturing the body panel 2, the latter includes the following steps:
Production of at least one support 10 made of plastic material. Depending on the material chosen, it may be designed by injection molding, compression molding, three-dimensional printing, etc.
Production of at least one covering 4. The latter can be designed by extrusion, weaving, etc., depending in particular on the choice of the material forming the covering or else the desired final appearance. The decorative design or designs 8 can be produced during the production of the covering 4, or once the latter has been produced, as described above.
Attaching the covering 4 to the support, as described above.

What is claimed is:

1. A motor vehicle body panel, comprising at least one covering of a thickness between 0.1 and 1.5 millimeter, forming a main body of the body panel, wherein the at least one covering being attached to at least one plastic support is adapted to form at least part of a frame of the body panel.

2. The body panel according to claim 1, wherein the at least one covering is selected from any one of: a solid plastic film, a perforated plastic covering, a woven natural fiber covering, and a knitted natural fiber covering.

3. The body panel according to claim 1, wherein the at least one covering is configured to elastically deform in tension in an extension plane of the covering of between 1% and 50%.

4. The body panel according to claim 1, wherein at least part of the covering comprises openings, wherein a size of the openings is between 1 millimeter and 50 millimeters.

5. The body panel according to claim 1, wherein at least part of the covering comprises at least one decorative design.

6. The body panel according to claim 5, wherein the at least one decorative design is formed by a material forming the covering when the covering is made of any one of: a woven plastic, a woven natural fiber, and a knitted natural fiber.

7. The body panel according to claim 1, wherein the covering is made based on at least one plastic material selected from polypropylene, polyamide, polyurethane, polyvinyl chloride, polyester, and elastane.

8. The body panel according to claim 1, wherein the covering is rigidly attached to the support by any one of: welding, gluing, riveting, and overmolding the covering on the support.

9. The body panel according to claim 1, wherein the covering is removably attached to the support by clamping of the covering by the support.

10. The body panel according to claim 1, wherein the support comprises a fastening part, wherein the part is adapted to fasten the body panel to a structure of a motor vehicle.

11. The body panel according to claim 1, comprising multiple supports on which at least one covering is attached.

12. The body panel according to claim 1, wherein the support is made based on at least one plastic material selected from polypropylene, polyamide, polyvinyl chloride, polyester, polybutylene terephthalate, or based on a composite material.

13. The body panel according to claim 1, wherein the covering is stretched over the support.

14. The body panel according to claim 1, wherein the support comprises at least one support bar for the covering.

15. The body panel according to claim 14, wherein at least one support bar extends over an external face of the covering.

16. The body panel according to claim 14, wherein the at least one support bar locally deforms the covering.

17. A method for manufacturing a motor vehicle body panel, comprising:
making at least one support, wherein the at least one support is made of a plastic material;
making at least one covering; and
attaching the at least one covering to the support,
wherein the motor vehicle body panel comprises: the at least one covering of a thickness between 0.1 and 1.5 millimeter, forming a main body of the body panel, wherein the at least one covering being attached to at least one plastic support is adapted to form at least part of a frame of the body panel.

18. The manufacturing method according to claim 17, further comprises:
making multiple plastic supports;
fixing the at least one covering on the supports and
folding the body panel over itself.

19. The body panel according to claim 1, wherein thickness of the at least one covering is between 0.3 and 0.7 millimeters.

20. The body panel according to claim 2, wherein the perforated plastic covering is a woven plastic covering.

21. The body panel according to claim 1, wherein the at least one covering is adapted to elastically deform between 3% and 10% in tension in an extension plane of the covering.

22. The body panel according to claim 1, wherein at least part of the covering comprises openings, wherein a size of the openings is between 10 millimeters and 40 millimeters.
